(19) United States
(12) Patent Application Publication
(10) Pub. No.: US 2026/0008270 A1
(43) Pub. Date: Jan. 8, 2026

(54) PRINTING APPARATUS, CONTROL METHOD FOR SAME, AND STORAGE MEDIUM

(71) Applicant: CANON KABUSHIKI KAISHA, Tokyo (JP)

(72) Inventors: TAKATOSHI NAKANO, Kanagawa (JP); YUTAKA KANO, Kanagawa (JP); TSUKASA SANO, Kanagawa (JP)

(21) Appl. No.: 19/257,639

(22) Filed: Jul. 2, 2025

(30) Foreign Application Priority Data
Jul. 8, 2024 (JP) 2024-109752

(51) Int. Cl. B41J 2/165

(52) U.S. Cl. CPC B41J 2/16508; B41P 2235/27

(57) ABSTRACT

A printing apparatus includes a cap configured to cap a printhead that ejects a liquid, a supplying mechanism configured to supply the cap with a cleaning liquid for rinsing out the liquid inside the cap, and a controlling unit configured to control an amount of the cleaning liquid supplied to the cap by the supplying mechanism in accordance with an amount of the liquid discharged from the printhead to the cap.

### CROSS REFERENCE TO PRIORITY APPLICATION

This application claims the benefit of Japanese Patent Application No. 2024-109752, filed Jul. 8, 2024, which is hereby incorporated by reference herein in its entirety.

### FIELD OF THE TECHNOLOGY

The present disclosure relates to a printing apparatus.

### DESCRIPTION OF THE RELATED ART

There is conventionally known a liquid ejection apparatus in which a waste-liquid flow path serving as a flow path of ink suctioned from nozzles is provided, and a cap is cleaned by supplying a cleaning liquid to the cap via the waste-liquid flow path.

Japanese Patent Laid-Open No. 2019-130812 discloses an apparatus in which a cleaning unit is controlled such that the amount of cleaning liquid supplied differs depending on the time elapsing from when an ink suctioning operation was performed.

However, conventional printing apparatuses had the following problem.

In a case in which ink is suctioned from nozzles by applying negative pressure to a cap, the amount of ink suctioned from the nozzles differs depending on the negative pressure reached during suction and the suction duration.

The amount of cleaning liquid necessary for cleaning the cap differs depending on the amount of ink discharged to the cap; thus, if the cap cleaning operation is performed under the same conditions, ink solidification in the waste-liquid flow path would occur if the amount of cleaning liquid is not enough. On the other hand, the cleaning liquid would be overconsumed if the amount of cleaning liquid is excessive.

### SUMMARY

The present disclosure has been made in view of the above-described problem, and provides a printing apparatus in which a cap can be cleaned appropriately using a cleaning liquid.

According to a first aspect of the present disclosure, there is provided a printing apparatus comprising: a cap configured to cap a printhead that ejects a liquid; a supplying mechanism configured to supply the cap with a cleaning liquid for rinsing out the liquid inside the cap; and at least one processor or circuit that executes a program and performs operations of the following units: a controlling unit configured to control an amount of the cleaning liquid supplied to the cap by the supplying mechanism in accordance with an amount of the liquid discharged from the printhead to the cap.

According to a second aspect of the present disclosure, there is provided a method for controlling a printing apparatus comprising: a cap configured to cap a printhead that ejects a liquid; and supplying mechanism configured to supply the cap with a cleaning liquid for rinsing out the liquid inside the cap, the method comprising controlling an amount of the cleaning liquid supplied to the cap by the supplying mechanism in accordance with an amount of the liquid discharged from the printhead to the cap.

Further features of the present disclosure will become apparent from the following description of exemplary embodiments with reference to the attached drawings.

### BRIEF DESCRIPTION OF THE DRAWINGS

FIG. 1 is a diagram illustrating a schematic configuration of an inkjet printing apparatus in a first embodiment.

FIG. 2 is a perspective view of a printhead.

FIG. 3 is a perspective view of a maintenance section (cap tray).

FIG. 4 is a perspective view of the maintenance section (cleaning tray).

FIG. 5 is a diagram illustrating a configuration of flow paths to the maintenance section.

FIG. 6 is a perspective view illustrating an arrangement of cleaning-liquid-and-negative-pressure-supplying units.

FIG. 7 is a perspective view illustrating a configuration of a cleaning-liquid-and-negative-pressure-supplying unit.

FIG. 8 is a perspective view illustrating a configuration of a cleaning-liquid-and-negative-pressure-supplying unit and the surroundings thereof.

FIG. 9 is a perspective view illustrating cleaning-liquid supply flow paths of the cap tray.

FIG. 10 is a perspective view of a cap upstream three-way valve in a cleaning-liquid supply flow path.

FIG. 11 is a front view illustrating an arrangement of cap upstream three-way valves.

FIG. 12 is a flowchart illustrating a suction operation upon arrival.

FIG. 13 is a flowchart illustrating a suction operation upon maintenance.

FIG. 14 is a flowchart illustrating a cap-cleaning operation.

FIG. 15 is a flowchart illustrating a cumulative preliminary-ejection count operation.

FIG. 16 is a flowchart illustrating an in-cap-evaporation-ratio count operation.

FIG. 17 is a parameter table for an in-cap-evaporation-ratio count value.

FIG. 18 is a flowchart illustrating a cap-cleaning determination operation.

### DESCRIPTION OF THE EMBODIMENTS

Hereafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

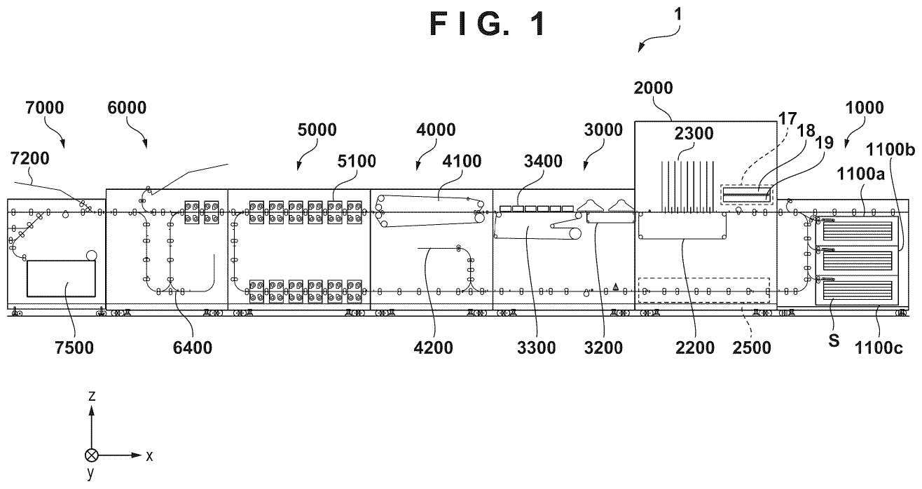

First, directions are defined as follows. The direction toward the apparatus upper side in FIG. 1 is defined as the upward direction (+z direction), the direction from the apparatus right side to the apparatus left side in FIG. 1 is defined as the longitudinal direction (−x direction), the direction from the near side to the far side of the drawing in the direction orthogonal to the sheet conveyance direction is defined as the sheet width direction (+y direction). Furthermore, the near side of the drawing is defined as the apparatus front side, and the far side of the drawing is defined as the apparatus back side. Note that, while a printhead and a printing apparatus will be described based on specific configurations thereof in the following embodiments, the present disclosure is not limited thereby. For example, the present disclosure is not only applicable to a line printer but is also applicable to a serial printer. Furthermore, the present disclosure is not only applicable to a sheet-fed printing apparatus but is also applicable to a roll-fed printing apparatus.

FIG. 1 is a schematic diagram illustrating a schematic configuration of an inkjet printing apparatus 1 (also referred to hereinafter as a printing apparatus 1) according to the present embodiment. This inkjet printing apparatus 1 is a sheet-fed inkjet printing apparatus that produces a printed material by forming an ink image on a sheet S using two liquids, namely a reaction liquid and ink.

The inkjet printing apparatus 1 according to the present embodiment includes the following modules: a sheet-feeding module 1000; a printing module 2000; a drying module 3000; a fixing module 4000; a cooling module 5000; a reversing module 6000, and a sheet-discharging-and-stacking module 7000.

A sheet S in the form of a cut sheet supplied from the sheet-feeding module 1000 is conveyed along a conveyance path to be processed by each module and discharged to the sheet-discharging-and-stacking module 7000.

Three storage compartments 1100a to 1100c for storing sheets S are disposed in the sheet-feeding module 1000, and the storage compartments 1100a to 1100c are configured so as to be capable of being pulled out toward the apparatus front side. In each of the storage compartments 1100a to 1100c, the sheets S are fed one at a time by a separation belt and conveying rollers to be conveyed to the printing module 2000. Note that the number of storage compartments 1100a to 1100c is not limited to three, and a configuration may be adopted in which one, two, or four or more storage compartments are included.

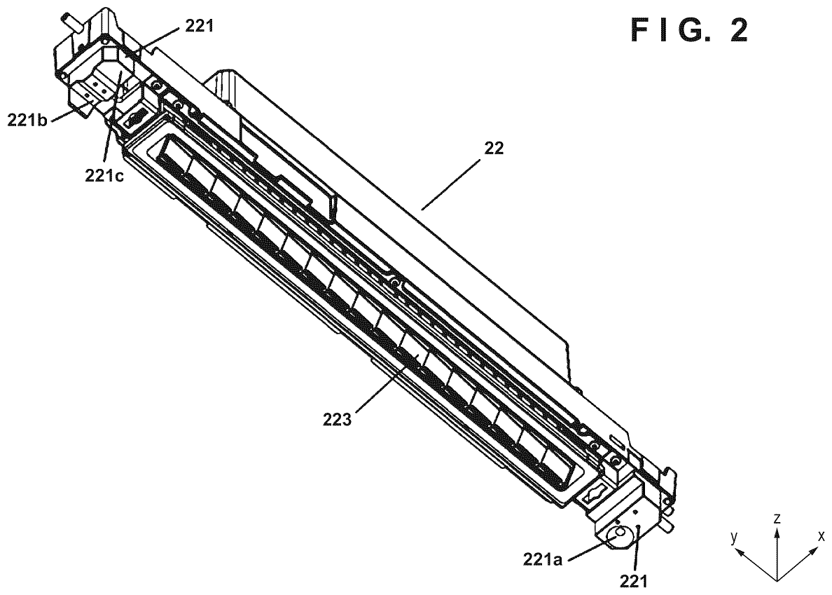

The printing module 2000 includes a pre-image-forming registration correction section (unillustrated), a printing belt unit 2200, and a printing section 2300. A sheet S conveyed from the sheet-feeding module 1000 is conveyed to the printing belt unit 2200 after sheet inclination and position are corrected by the pre-image-forming registration correction section. In the conveyance path, the printing section 2300 is disposed in a position facing the printing belt unit 2200. The printing section 2300 is a sheet processing section that forms an image on the conveyed sheet S by performing recording processing (printing) from above by means of printheads 22 (see FIG. 2).

A clearance between the sheet S and the printheads 22 is secured by the sheet S being conveyed while being attracted by the printing belt unit 2200. Furthermore, a plurality of the printheads 22 are disposed so as to be arranged along the conveyance direction. In the present example, a total of five line-type printheads corresponding to the four colors yellow (Y), magenta (M), cyan (C), and black (Bk), and also a reaction liquid (P) are included. Note that the number of colors and the number of printheads 22 are not limited to five.

As the inkjet method, a method in which heating elements are used, a method in which piezoelectric elements are used, a method in which electrostatic elements are used, a method in which MEMS elements are used, etc., may be adopted. Ink of each color is supplied from an unillustrated ink tank to the corresponding printhead 22 via an ink tube. The sheet S subjected to printing by the printing section 2300 is conveyed by the printing belt unit 2200. Furthermore, the print image can be corrected by detecting misalignment and color density of the image formed on the sheet S by means of an inline scanner (unillustrated) that is disposed on the conveyance-direction downstream-side of the printing section 2300.

The drying module 3000 includes a decoupling section 3200, a drying belt unit 3300, and a hot-air blowing section 3400; the drying module 3000 is a unit for increasing the fixation between the sheet S and ink having been applied on the sheet S by the printing section 2300 by reducing the liquid content included in the ink. The sheet S having been subjected to printing by the printing section 2300 of the printing module 2000 is conveyed to the decoupling section 3200 disposed inside the drying module 3000.

In the decoupling section 3200, the sheet S is conveyed by wind pressure from above and belt friction. By conveying the sheet S in a state in which the sheet S on the belt is weakly held, displacement of the sheet S on the printing belt unit 2200 forming the ink image is prevented.

The sheet S conveyed from the decoupling section 3200 is conveyed by the drying belt unit 3300 while being attracted thereto; at the same time, hot air is applied to the sheet S from the hot-air blowing section 3400 disposed above the belt to dry the ink application surface of the sheet S. Note that, as the drying method, a method of irradiating the surface of the sheet S with electromagnetic waves (such as ultraviolet rays or infrared rays) and a conduction heat transfer method involving contact with a heating member can be combined and used in addition to the method involving application of hot air.

The fixing module 4000 includes a fixing belt unit 4100, and fixes ink onto the sheet S conveyed from the drying module 3000 by passing the sheet S between heated upper and lower belt units.

The cooling module 5000 includes a plurality of cooling sections 5100, and cools the hot sheet S conveyed from the fixing module 4000. The cooling sections 5100 use a fan to take in outside air into a cooling box and increase the pressure inside the cooling box, and jet the air from nozzles formed in a conveyance guide. The sheet S can be cooled by applying the jetted air onto the sheet S. The sheet S can be cooled from both sides as a result of cooling sections 5100 being disposed on both sides of the conveyance path.

Furthermore, a conveyance-path-switching section is disposed inside the cooling module 5000. The conveyance-path-switching section can switch the conveyance path of the sheet S depending on whether the sheet S is to be conveyed to the reversing module 6000 or to a duplex conveyance path used during duplex printing. During duplex printing, the sheet S is conveyed to the lower conveyance path in the cooling module 5000, and is further conveyed along the duplex conveyance path in the fixing module 4000, the drying module 3000, the printing module 2000, and the sheet-feeding module 1000. Then, the sheet S is conveyed to the pre-image-forming registration correction section, the printing belt unit 2200, and the printing section 2300 of the printing module 2000 to be subjected to printing by the printing section 2300 once again. A first reversing section 4200 that reverses the front and back sides of the sheet S is disposed in the duplex conveyance section of the fixing module 4000.

The reversing module 6000 includes a second reversing section 6400, and can reverse the front and back sides of the conveyed sheet S. Thus, the orientation of the front and back sides of the discharged sheet S can be freely changed.

The sheet-discharging-and-stacking module 7000 includes a top tray 7200 and a stacking section 7500, and aligns and stacks sheets S conveyed from the reversing module 6000.

A maintenance section 17 is a unit that includes mechanisms for restoring the ejection performance of the printheads 22. For example, as such mechanisms, cap mechanisms that perform capping for protecting ink ejection surfaces of the printheads 22, wiper mechanisms that wipe the ink ejection surfaces, and suction mechanisms that perform negative-pressure suction of ink inside the printheads 22 from the ink ejection surfaces can be mentioned. Furthermore, unillustrated drive mechanisms and rails are disposed in the maintenance section 17, and the maintenance section 17 can reciprocate horizontally along the rails. The maintenance section 17 moves to a position immediately below the printheads 22 during maintenance of the printheads 22, and moves to a position in which the maintenance section 17 is retracted from the position immediately below the printheads 22 when the maintenance operation is not performed.

### Configuration of Printhead

FIG. 2 is a perspective view of a printhead 22. As illustrated in FIG. 2, in the printhead 22, nozzle plates 223 provided with a plurality of nozzles for ejecting ink are disposed in an array in the longitudinal direction of the printhead 22 (sheet width direction, y direction). Furthermore, positioning portions 221 are provided at the two ends of the printhead 22. Specifically, a first contact portion 221a that is formed from a recess having a conical sloped surface is provided at the near side in the head longitudinal direction, and a second contact portion 221b that is formed from a groove portion provided with two flat surfaces forming a V shape, and a third contact portion 221c formed from a flat surface portion are provided at the far side in the head longitudinal direction.

### Configuration of Maintenance Section

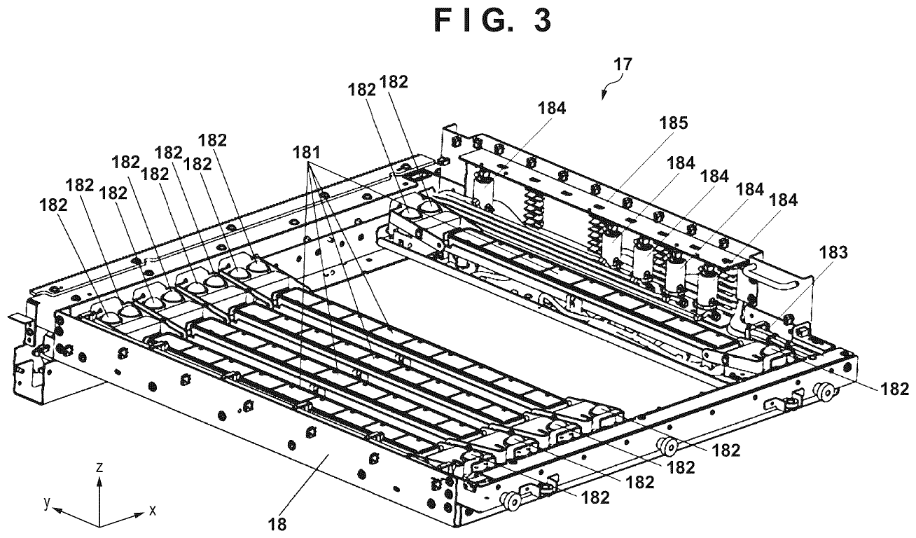

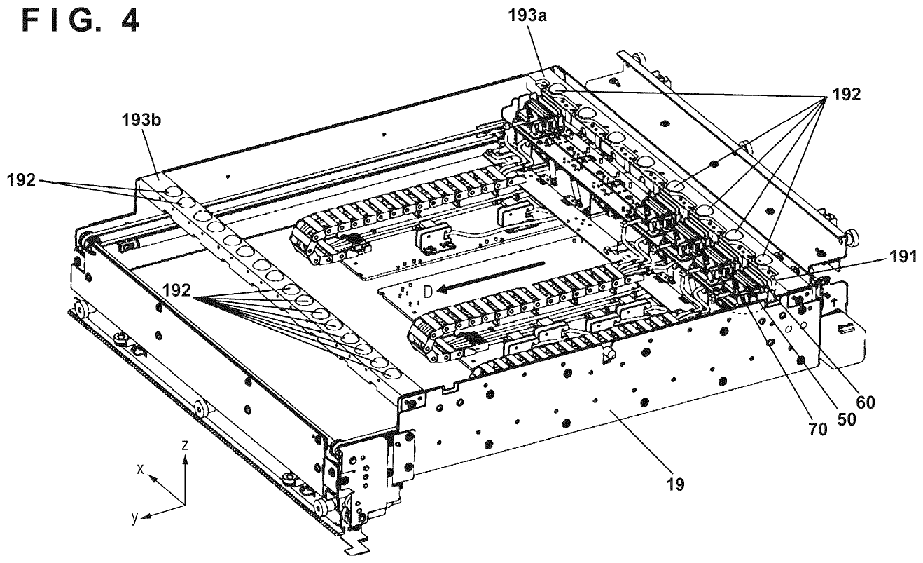

Next, a configuration of the maintenance section 17 of the printing apparatus 1 will be described with reference to FIGS. 3 and 4.

In the present embodiment, the maintenance section 17 is separated into a cap tray 18 in which cap mechanisms 181 (see FIG. 3) are disposed, and a cleaning tray 19 in which cleaning mechanisms 191 (see FIG. 4) are disposed. The cap tray 18 and the cleaning tray 19 are configured to be movable in the apparatus longitudinal direction (x direction) by means of an unillustrated drive motor and rail provided to the housing.

As illustrated in FIG. 3, in order to position a printhead 22, each cap mechanism 181 in the cap tray 18 includes a plurality of spherical head-positioning members 182 that face the printhead 22. The head-positioning members 182 are disposed at the sheet-width-direction (y-direction) front and rear ends of the cap mechanism 181. Three head-positioning members 182 are necessary to position one printhead 22 relative to the cap mechanism 181; one is disposed in the near side and two are disposed in the far side of the cap mechanism 181.

The printhead 22 and the cap mechanism 181 are positioned relative to one another by the positioning portions 221 provided at the two ends of the printhead 22 coming into contact with the head-positioning members 182 of the cap mechanism 181. By being positioned relative to the printhead 22, the cap mechanism 181 can protect the nozzle plates 223 of the printhead 22 and perform negative-pressure suction by a later-described negative-pressure-suction mechanism.

As illustrated in FIG. 4, in order to position the plurality of printheads 22, the cleaning tray 19 includes a plurality of spherical head-positioning members 192 that face the printheads 22. In the cleaning tray 19, the head-positioning members 192 are disposed at the sheet-width-direction (y-direction) front and rear ends, and are held by beam members 193a and 193b disposed so as to extend in the sheet conveyance direction. Three head-positioning members 192 are necessary to position one printhead 22 relative to the cleaning tray 19; one is disposed on the near-side beam member 193a, and two are disposed on the far-side beam member 193b in the cleaning tray 19. A printhead 22 and the cleaning tray 19 are positioned relative to one another by the positioning portions 221 provided at the two ends of the printhead 22 coming into contact with head-positioning members 192 of the cleaning tray 19.

Note that the positioning configuration is not limited to that in which spherical positioning members are used, and a configuration in which parts of the printheads 22 are butted against the inside of the cleaning tray 19, a configuration in which positioning is established using holes and pins provided to the cleaning tray 19 and the printheads 22, etc., can also be used.

Each cleaning mechanism 191 includes a cleaning-liquid-applying unit 50 that applies a cleaning liquid to the nozzle plates 223 of a printhead 22, and a liquid-removing unit 60 for removing ink, paper dust, and cleaning liquid adhering to the printhead 22. Furthermore, the cleaning mechanism 191 includes a negative-pressure-applying unit 70 for applying negative pressure to the nozzle plates 223 of the printhead 22 to remove ink that has solidified on the nozzle portions and bubbles inside ink flow paths.

Furthermore, as illustrated in FIG. 4, the cleaning tray 19 includes an unillustrated moving mechanism that moves the cleaning mechanism 191 in a wiping direction D that is orthogonal to the sheet conveyance direction. By means of the combination of the cleaning-liquid-applying unit 50, the liquid-removing unit 60, and the negative-pressure-applying unit 70, the cleaning mechanism 191 removes ink and dust on the nozzle surface of the printhead 22.

### Configuration of Flow Paths

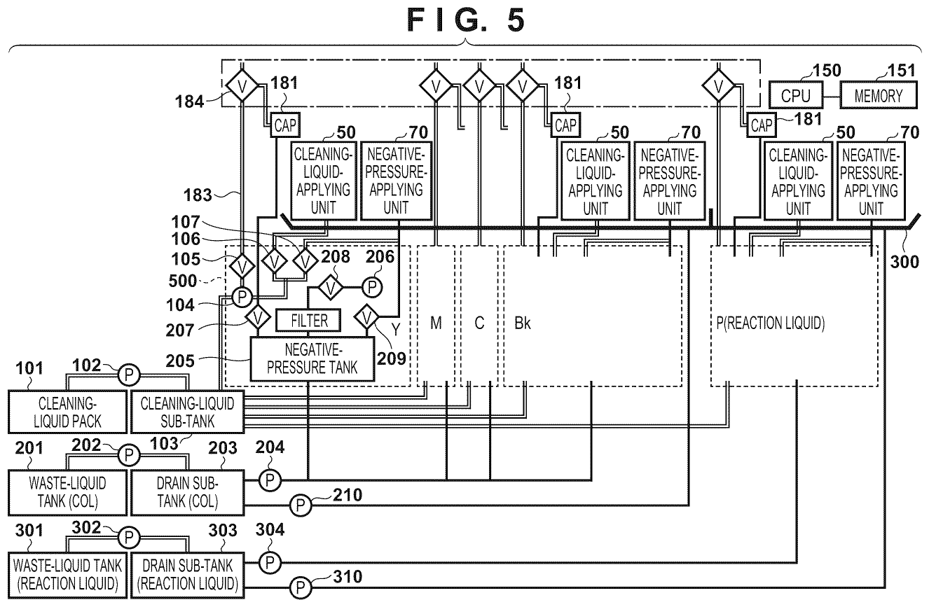

Next, cleaning-liquid supply paths, negative-pressure-suction flow paths, and waste-liquid flow paths will be described with reference to FIG. 5.

The cleaning liquid is delivered from a cleaning-liquid pack 101 to a cleaning-liquid sub-tank 103 by a pump 102. Furthermore, the cleaning liquid can be delivered from the cleaning-liquid sub-tank 103 to the cap mechanism 181, the cleaning-liquid-applying unit 50, and the negative-pressure-applying unit 70 by a cleaning-liquid-supplying pump 104 provided in a cleaning-liquid-and-negative-pressure-supplying unit 500 (Y, M, C, Bk, and P) corresponding to each head. Furthermore, the timing at which the cleaning liquid is supplied to each of the cap mechanism 181, the cleaning-liquid-applying unit 50, and the negative-pressure-applying unit 70 can be controlled by on-off valves 105 to 107.

The application of negative pressure to the cap mechanism 181 and the negative-pressure-applying unit 70 is performed by a suction pump 206 connected to a negative-pressure tank 205. Negative pressure can be applied from the negative-pressure tank 205 to the cap mechanism 181 and the negative-pressure-applying unit 70 via on-off valves 207 to 209.

Waste liquid suctioned from a printhead 22 when negative-pressure suction is performed in the cap mechanism 181 or the negative-pressure-applying unit 70 is stored in a drain sub-tank 203 from the negative-pressure tank 205 by a pump 204, and is further accumulated in a waste-liquid tank 201 by a pump 202.

Furthermore, a collection tray 300 for collecting the cleaning liquid overflowing from the cleaning-liquid-applying unit 50 is provided, and the collected cleaning liquid is delivered to the drain sub-tank 203 by a pump 210.

The approach of the waste-liquid tank 201 to the maximum capacity thereof is detected by an unillustrated waste-liquid-tank detection sensor to urge the user to replace the waste-liquid tank 201.

Note that waste liquid from the reaction liquid (P) head is stored in a drain sub-tank 303 for the reaction liquid by a pump 304 and is further accumulated in a waste-liquid tank 301 for the reaction liquid by a pump 302, separately from the waste-liquid flow path for the color ink heads (Y, M, C, and Bk). Accordingly, because the reaction liquid (P) and color inks (Y, M, C, and Bk) do not mix inside the waste-liquid flow path, ink solidification in the flow path and the consequent clogging of the flow path can be prevented.

As can be seen from the flow-path configuration described above, the cleaning-liquid-and-negative-pressure-supplying unit 500 (Y, M, C, Bk, and P) corresponding to each head is provided with the cleaning-liquid-supplying pump 104 and the on-off valves 105 to 107 for controlling the supply of the cleaning liquid to flow paths. Furthermore, the negative-pressure tank 205, the suction pump 206 for negative-pressure suction, and the on-off valves 207 to 209 for controlling the application of negative pressure to portions are provided. In the present embodiment, in the individual ones of the cleaning-liquid-and-negative-pressure-supplying units 500 (Y, M, C, Bk, and P) corresponding to the respective heads, the necessary electric devices and on-off valves are integrated into a unit in such a manner.

Note that the inkjet printing apparatus 1 includes a central processing unit (CPU) 150, and the blocks illustrated in FIG. 5 described above are controlled by the CPU 150 executing one or more control programs stored in a memory 151. Furthermore, the operations in the flowcharts described in the following are realized by the CPU 150 executing the control programs stored in the memory 151.

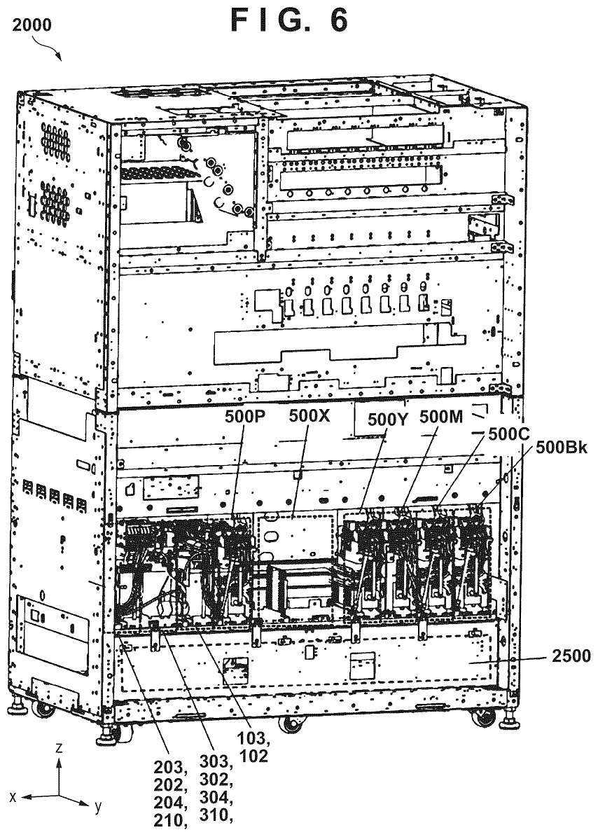

Next, a configuration of the cleaning-liquid-and-negative-pressure-supplying units in the present embodiment will be described with reference to FIGS. 6, 7, and 8.

FIG. 6 is a diagram illustrating the printing module 2000 in FIG. 1 as seen from the apparatus back side. As illustrated in FIG. 6, the cleaning-liquid-and-negative-pressure-supplying units 500 (Y, M, C, Bk, and P), which are configured as units, are disposed in the lower apparatus back side of the printing module 2000. Furthermore, the cleaning-liquid sub-tank 103 and the pump 102, the drain sub-tank 203 and the pumps 202, 204, and 210, and the drain sub-tank 303 for the reaction liquid and the pumps 302, 304, and 310 are disposed so as to be arranged in the longitudinal direction (x direction).

Note that, between the cleaning-liquid-and-negative-pressure-supplying unit 500P (for the reaction liquid) and the cleaning-liquid-and-negative-pressure-supplying unit 500Y (for the yellow ink), a space 500X is provided in which a cleaning-liquid-and-negative-pressure-supplying unit can be additionally disposed in a case in which the number of colors and the number of printheads 22 are more than those in the present embodiment. Furthermore, in a portion further below the portion in which these cleaning-liquid-and-negative-pressure-supplying units 500 (Y, M, C, Bk, and P) are disposed, a space is provided in which a duplex conveyance path 2500 (FIG. 1) in which sheets S are conveyed during duplex printing is disposed.

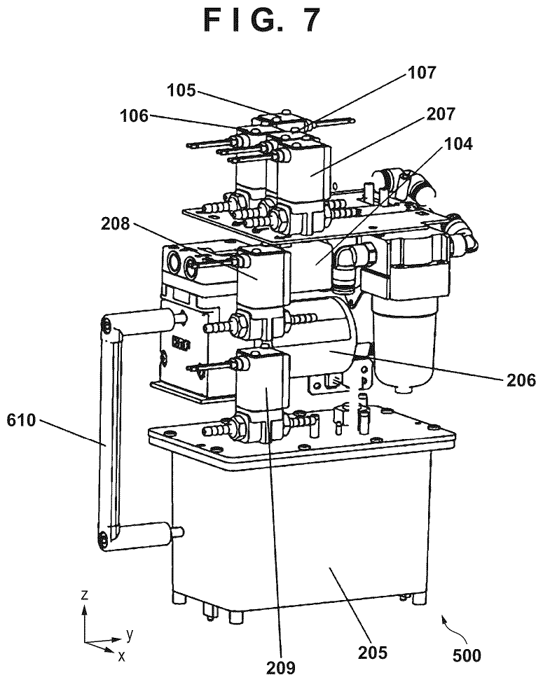

FIG. 7 is a perspective view illustrating the arrangement of the negative-pressure tank 205 and various pumps disposed inside a cleaning-liquid-and-negative-pressure-supplying unit 500. As illustrated in FIG. 7, in each cleaning-liquid-and-negative-pressure-supplying units 500, the negative-pressure tank 205 is disposed in the lower side of the unit, and the cleaning-liquid-supplying pump 104, the pump 206 for negative-pressure suction, and the on-off valves 105 to 107 and on-off valves 207 to 209 are disposed above the negative-pressure tank 205. Thus, even if liquid leakage from the negative-pressure tank 205 storing an ink or the reaction liquid occurs, the risk can be reduced of electrical components such as the cleaning-liquid-supplying pump 104 and the pump 206 for negative-pressure suction failing due to the ink or reaction liquid spilling thereon.

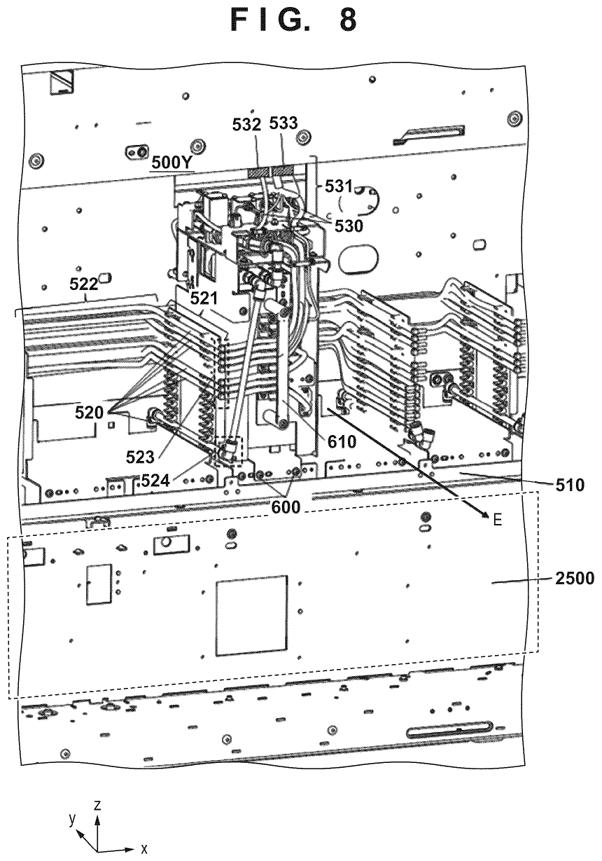

FIG. 8 is a diagram illustrating a state in which the cleaning-liquid-and-negative-pressure-supplying unit 500Y is disposed inside the apparatus main body, and the adjacent cleaning-liquid-and-negative-pressure-supplying units 500M and 500C are removed.

Liquid tubes 520 connected to the cleaning-liquid-and-negative-pressure-supplying unit 500Y are connected to the connection destinations thereof after passing over a back-surface portion (522) from a side surface (521) of the cleaning-liquid-and-negative-pressure-supplying unit 500Y Furthermore, electrical harnesses 530 for connection to the electrical components in the cleaning-liquid-and-negative-pressure-supplying unit 500Y are connected to the apparatus main body via electrical connectors 532 and 533 on the upper-surface side (531) of the cleaning-liquid-and-negative-pressure-supplying unit 500Y.

Upon removing the cleaning-liquid-and-negative-pressure-supplying unit 500Y from the apparatus main body, tube joints 523 and 524 are unplugged on the side surface (521) of the cleaning-liquid-and-negative-pressure-supplying unit 500Y. Furthermore, the electrical connectors 532 and 533 are unplugged on the upper surface (531) of the cleaning-liquid-and-negative-pressure-supplying unit 500Y Thus, the ink-liquid connection and electrical connection between the cleaning-liquid-and-negative-pressure-supplying unit 500Y and the apparatus main body can be easily released.

Furthermore, screws 600 fixing the cleaning-liquid-and-negative-pressure-supplying unit 500Y to the apparatus main body at the near side of the cleaning-liquid-and-negative-pressure-supplying unit 500Y are unscrewed. Then, the cleaning-liquid-and-negative-pressure-supplying unit 500Y can be removed from the apparatus main body by holding an attachment/detachment handle 610 and pulling out the cleaning-liquid-and-negative-pressure-supplying unit 500Y in the arrow E direction.

In doing so, the liquid tubes 520 and the electrical harnesses 530 to be connected to the cleaning-liquid-and-negative-pressure-supplying unit 500Y are disposed on the unit back surface (522) and the upper surface (531), where removal in the removal direction (arrow E) of the cleaning-liquid-and-negative-pressure-supplying unit 500 is not interrupted. Thus, the cleaning-liquid-and-negative-pressure-supplying units 500 can be easily removed without interruption. Note that a liquid-leakage prevention tray 510 is disposed below the portion where the cleaning-liquid-and-negative-pressure-supplying units 500 are disposed, and an unillustrated leakage-detecting sensor is disposed inside the liquid-leakage prevention tray 510.

Even if liquid leakage from a negative-pressure tank 205 storing an ink or the reaction liquid occurs, the ink or reaction liquid having leaked is accumulated inside the liquid-leakage prevention tray 510 because the liquid-leakage prevention tray 510 is provided so as to cover the entire lower surface of all cleaning-liquid-and-negative-pressure-supplying units 500. Furthermore, because liquid inside the liquid-leakage prevention tray 510 can be detected by the unillustrated leakage-detecting sensor, appropriate processing, such as the stopping of the apparatus, can be performed immediately if liquid is detected. Thus, the leakage of ink or the reaction liquid to the duplex conveyance path 2500 disposed below the portion where the cleaning-liquid-and-negative-pressure-supplying units 500 are disposed can be prevented.

Note that the paths of the liquid tubes 520 and the electrical harnesses 530 are not limited to being respectively disposed on the back-surface portion and the upper-surface portion of each cleaning-liquid-and-negative-pressure-supplying units 500, and may be disposed on the back-surface portion, the upper-surface portion, the lower-surface portion, etc. Thus, a unit configuration can be obtained with which the cleaning-liquid-and-negative-pressure-supplying units 500 can be removed easily without interference as discussed above.

As described up to this point, in the printing apparatus 1 according to the present embodiment, the cleaning-liquid-supplying pump 104, the on-off valves 105 to 107 for controlling the supply of the cleaning liquid to flow paths, the negative-pressure tank 205, the suction pump 206 for negative-pressure suction, and the on-off valves 207 to 209 for controlling the application of negative pressure to portions, which correspond to the cleaning configuration of each head, are integrated into a unit in the cleaning-liquid-and-negative-pressure-supplying units 500. Thus, portions corresponding to the cleaning configuration of each head can be easily removed to carry out replacement and maintenance work.

Furthermore, the liquid tubes 520 and the electrical harnesses 530 connected to each cleaning-liquid-and-negative-pressure-supplying unit 500 are disposed on the unit back surface, upper surface, or lower surface, where removal in the removal direction (arrow E) of the cleaning-liquid-and-negative-pressure-supplying unit 500 is not interrupted. Thus, the cleaning-liquid-and-negative-pressure-supplying units 500 can be removed easily without interruption.

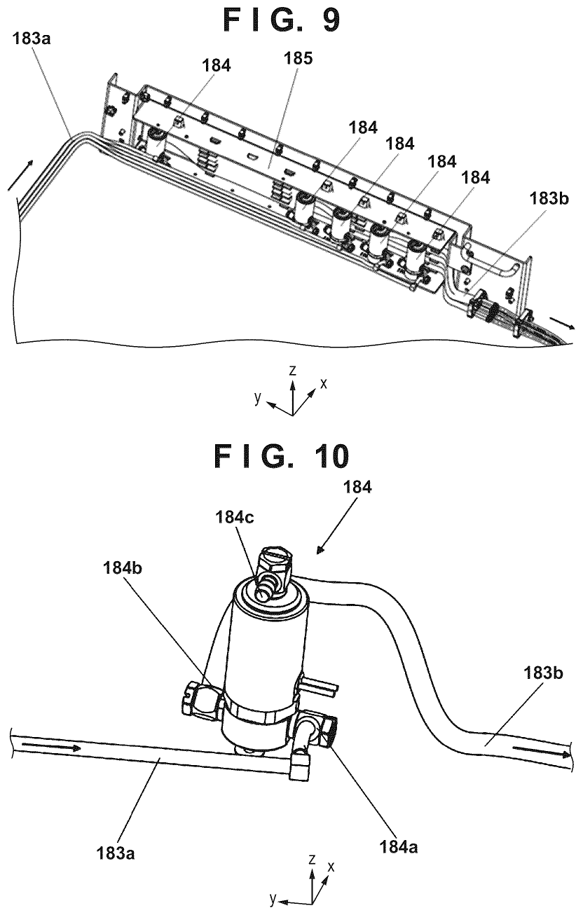

Configuration of Three-Way Valve in Cleaning-Liquid Supply Flow Path Next, a configuration of a three-way valve in a cleaning-liquid supply flow path for supplying the cleaning liquid to a cap mechanism 181 in the present embodiment will be described with reference to FIGS. 9, 10, and 11.

FIG. 9 is a perspective view of cleaning-liquid supply flow paths 183 in the cap tray 18. As illustrated in FIG. 9, the cleaning-liquid supply flow paths 183 for the cap mechanisms 181 corresponding to the printheads 22 are provided with a plurality of cap upstream three-way valves 184, and each include a three-way-valve upstream flow path 183a and a three-way-valve downstream flow path 183b. The plurality of cap upstream three-way valves 184 are supported by a three-way-valve-supporting member 185 by an unillustrated fixing method.

FIG. 10 is a perspective view of a cap upstream three-way valve 184. As illustrated in FIG. 10, the cap upstream three-way valve 184 includes a three-way-valve inlet 184a, a three-way-valve supply outlet 184b, and a three-way-valve atmosphere communication port 184c. The three-way-valve inlet 184a is connected to the three-way-valve upstream flow path 183a, and the three-way-valve supply outlet 184b is connected to the three-way-valve downstream flow path 183b. The cap upstream three-way valve 184 can switch between an atmosphere non-communication state in which the three-way-valve inlet 184a and the three-way-valve supply outlet 184b are connected, and the three-way-valve atmosphere communication port 184c is closed, and an atmosphere communication state in which the three-way-valve inlet 184a is closed, and the three-way-valve supply outlet 184b and the three-way-valve atmosphere communication port 184c are connected.

In the atmosphere non-communication state, the cleaning liquid can be supplied from a cleaning-liquid-supplying pump 104 to a cap mechanism 181 because the three-way-valve upstream flow path 183a and the three-way-valve downstream flow path 183b are connected. In the atmosphere communication state, the interior of the cap mechanism 181 can be vented to the atmosphere because the three-way-valve downstream flow path 183b and the three-way-valve atmosphere communication port 184c are connected. Thus, the negative pressure inside the cap mechanism 181 can be released after a printhead 22 is subjected to negative-pressure suction by the cap mechanism 181 and a negative-pressure-applying unit 70. Thus, the operation load for separating the cap mechanism 181 from the printhead 22 can be reduced.

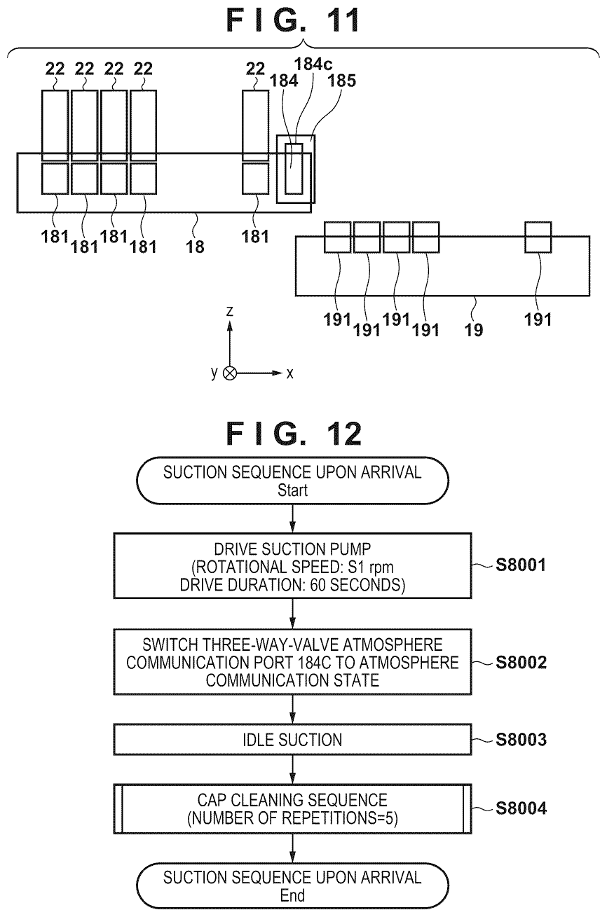

FIG. 11 is a front view illustrating the arrangement of the cap upstream three-way valves 184 and the three-way-valve-supporting member 185. As illustrated in FIGS. 3 and 11, the three-way-valve-supporting member 185 is disposed in the apparatus-longitudinal-direction-right-side (+x direction) end portion of the cap tray 18. Thus, in a state in which the printheads 22 are capped by the cap mechanisms 181, the attachment/removal of the three-way-valve-supporting member 185 and maintenance work on the cap upstream three-way valves 184 can be performed. Furthermore, by moving the cleaning tray 19 to the apparatus right side using an apparatus-longitudinal-direction (x-direction) movement means of the cleaning tray 19, maintenance work on the cleaning mechanisms 191 can also be performed.

Furthermore, as illustrated in FIG. 11, the cap upstream three-way valves 184 are disposed so that the three-way-valve atmosphere communication port 184c thereof is positioned higher than the surfaces of the cap mechanisms 181 for capping the printheads 22. Thus, a situation can be avoided in which, upon release of the negative pressure inside a cap mechanism 181 from the three-way-valve atmosphere communication port 184c, an ink or the cleaning liquid remaining in the three-way-valve downstream flow path 183b spills out from the three-way-valve atmosphere communication port 184c.

In the present embodiment, the three-way-valve-supporting member 185 is disposed in the apparatus-longitudinal-direction-right-side (+x direction) end portion of the cap tray 18; however, the three-way-valve-supporting member 185 may be disposed in the apparatus-front-side (−y-direction) end portion of the cap tray 18. In this case, while the cap tray 18 needs to be expanded in the apparatus-front-side direction, the cap tray 18 can be reduced in size in the apparatus-right-side direction (+x direction).

In negative-pressure-suction operations using a cap mechanism 181, suction-pump rotational speed and suction-pump drive duration are changed in accordance with the purpose of the operation. Specifically, in order to fill a printhead 22 with ink upon arrival of the printing apparatus 1, a fast rotational speed is set and a long drive duration is secured to fill the printhead 22 with ink. On the other hand, during a negative-pressure-suction operation performed as daily maintenance for removing dust, paper dust, etc., adhering to the printhead 22, a slow rotational speed is set and a relatively short drive duration is set. Thus, a large amount of ink is discharged from the printhead 22 upon arrival of the printing apparatus 1, and a small amount of ink is discharged from the printhead 22 during daily maintenance (preliminary eject operation, etc.). Furthermore, it is known that the amount of cleaning liquid necessary for cleaning the cap mechanism 181 differs depending on the amount of ink that has been discharged. Thus, as described in the following, the cap cleaning operation is changed in accordance with the negative-pressure-suction operation.

FIG. 12 is a diagram illustrating a suction sequence upon arrival of the printing apparatus 1.

The suction pump 206 is driven for 60 seconds at rotational speed S1 (rpm) (step S8001).

The three-way-valve atmosphere communication port 184c is switched to the atmosphere communication state to place the cap mechanism 181 in communication with the atmosphere (step S8002).

Subsequently, an idle suction operation is performed (step S8003). Idle suction is processing in which ink having been discharged to the cap mechanism 181 is suctioned using the suction pump 206 in a state in which the cap mechanism 181 is in communication with the atmosphere.

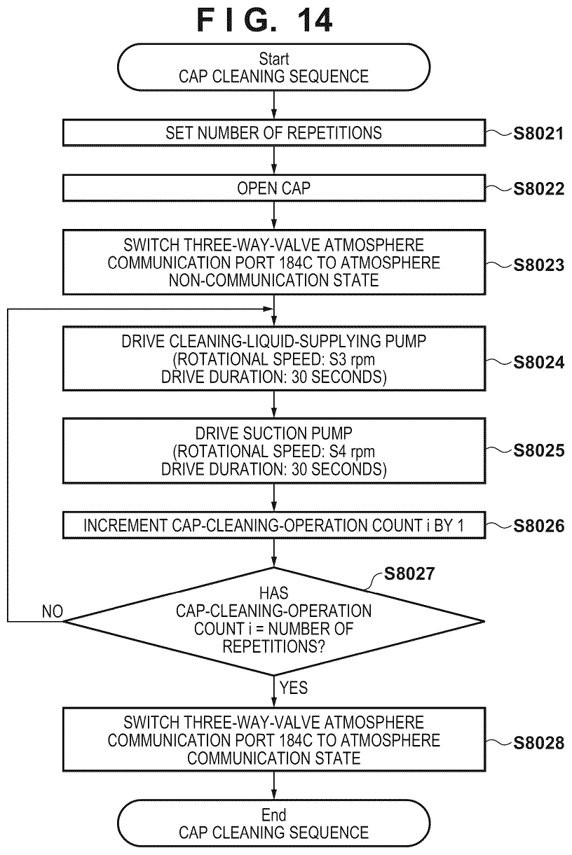

Finally, a cap cleaning operation is executed in a state in which the number of repetitions is set to five times (step S8004). The cap cleaning operation will be described in detail later with reference to FIG. 14. In the suction sequence upon arrival of the printing apparatus 1, because a large amount of ink is discharged from the printhead 22, the solidification of ink remaining in the cap mechanism 181 can be prevented by repeating the cap cleaning operation five times.

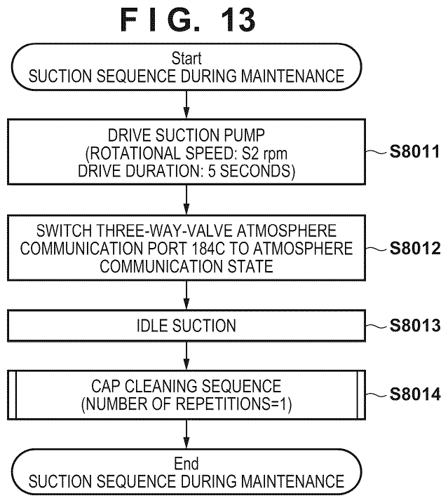

FIG. 13 is a diagram illustrating a suction sequence during daily maintenance.

The suction pump 206 is driven for 10 seconds at rotational speed S2 (rpm) (S2<S1) (step S8011).

The three-way-valve atmosphere communication port 184c is switched to the atmosphere communication state to place the cap mechanism 181 in communication with the atmosphere (step S8012). Subsequently, the idle suction operation is performed (step S8013).

Finally, the cap cleaning operation is executed in a state in which the number of repetitions is set to one (step S8014). In the suction sequence executed during daily maintenance, because a small amount of ink is discharged from the printhead 22, the solidification of ink remaining in the cap mechanism 181 can be prevented by performing the cap cleaning operation once.

FIG. 14 is a diagram illustrating a cap cleaning sequence.

A parameter indicating the number of repetitions is set upon execution of the cap cleaning operation in the sequences in FIGS. 12 and 13 (step S8021). For example, as described with reference to FIGS. 12 and 13, the number of repetitions is set to five upon arrival of the printing apparatus 1, and is set to one during daily maintenance.

Subsequently, the cap is opened (the cap mechanism 181 is separated from the printhead 22) (step S8022).

Next, the three-way-valve atmosphere communication port 184c is switched to the atmosphere non-communication state (step S8023). Subsequently, the cleaning liquid is supplied to the cap mechanism 181 by driving the cleaning-liquid-supplying pump 104 for 30 seconds at rotational speed S3 (rpm) (step S8024).

Subsequently, the suction pump 206 is driven for 30 seconds at rotational speed S4 (rpm) (S3<S4) to discharge the cleaning liquid including ink from the cap mechanism 181 (step S8025).

Next, a cap-cleaning-operation count i is incremented by one (step S8026). The cap-cleaning-operation count i is a variable for managing how many times the cap cleaning operation has been executed.

Finally, it is determined whether the cap-cleaning-operation count i has reached the number of repetitions set in step S8021 (step S8027). If the cap-cleaning-operation count i has not reached the number of repetitions, the operations (steps S8024 to S8026) from the driving of the cleaning-liquid-supplying pump 104 are repeated. If the cap-cleaning-operation count i has reached the number of repetitions, the sequence ends after the three-way-valve atmosphere communication port 184c is switched to the atmosphere communication state (step S8028).

In such a manner, by changing the amount of cleaning liquid supplied in accordance with the amount of ink discharged to the cap mechanism 181, the excessive use of the cleaning liquid can be suppressed in each state of use while preventing the solidification of ink in the cap mechanism 181 and the waste-liquid flow path.

Note that, in the present embodiment, a set of a cleaning-liquid supply operation and a cleaning-liquid discharge operation is repeated, and the amount of cleaning liquid supplied is changed based on the number of repetitions. However, the amount of cleaning liquid supplied may be changed by changing the drive duration of the cleaning-liquid-supplying pump 104 in one cleaning-liquid supply operation.

### Second Embodiment

In the present embodiment, a cap cleaning operation when ink has been discharged to the cap mechanism 181 due to preliminary ejection will be described.

The preliminary-ejection count of ejection in preliminary ejection differs depending on the purpose. Here, it is supposed that 1 shot of preliminary ejection is performed by preliminary ejection A, and 100 shots of preliminary ejection is performed by preliminary ejection B. Even in preliminary ejection B, in which the number of shots (number of ejections) is relatively high, the amount of ink discharged to the cap mechanism 181 is less than that in the suction sequence described in the first embodiment; thus, the cap cleaning operation does not need to be performed each time discharge is performed. Thus, a cumulative preliminary-ejection shot count (cumulative liquid ejection amount) is counted to determine a cap-cleaning-operation timing.

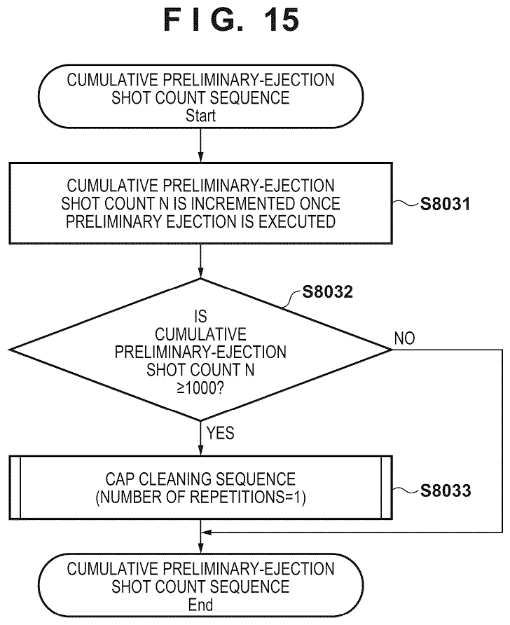

FIG. 15 is a diagram illustrating a cumulative preliminary-ejection count sequence. The cumulative preliminary-ejection shot count N is incremented once preliminary ejection A or preliminary ejection B is executed (step S8031).

Next, it is determined whether the cumulative preliminary-ejection shot count N is more than or equal to a threshold (1000 in the present embodiment) (step S8032). The result of the determination is “Yes” if the cumulative preliminary-ejection shot count N is more than or equal to the threshold, and a cap cleaning operation (number of repetitions=1) is executed immediately thereafter (step S8033). On the other hand, no cap cleaning operation is executed if the cumulative preliminary-ejection shot count N is less than the threshold.

By changing the cap-cleaning-operation timing in accordance with the amount of ink discharged to the cap mechanism 181 by preliminary ejection in such a manner, the excessive use of the cleaning liquid can be suppressed in each state of use while preventing the solidification of ink in the cap mechanisms 181 and the waste-liquid flow path.

### Third Embodiment

Inks and cleaning liquids typically contain a moisture component, such as water, and a moisture-retaining component, such as a solvent and/or a humectant, and are prone to a drop in water vapor pressure. The drop in water vapor pressure is determined by the mole fraction, and the water vapor pressure, i.e., the partial pressure of water vapor, in an ink or cleaning liquid can be calculated using (1) below.

(1) Water-vapor partial pressure in ink=saturation water vapor pressure at given temperature x mole fraction (%) of moisture in ink. On the other hand, humidity typically refers to relative humidity (%), and is obtained by dividing the water-vapor partial pressure included in the atmosphere at a given temperature by the saturation water vapor at the same temperature. This, represented in another way, can be represented as in (2) below.

(2) Water vapor partial pressure in atmosphere=saturation water vapor pressure at given temperature×relative humidity (%). The ink or cleaning liquid evaporates or absorbs moisture so as to fill the gap between the water vapor partial pressure in the ink or cleaning liquid and the water vapor partial pressure at the given temperature and humidity to approach a state of equilibrium, and the evaporation/moisture absorption rate in doing so equals the difference between formulae (1) and (2) above. That is, it is known that the evaporation/moisture absorption rate is proportional to (3) below.

(3) Mole fraction (%) of moisture in ink or cleaning liquid−relative humidity (%). The moisture in the ink or cleaning liquid evaporates if the mole fraction of moisture in the ink or cleaning liquid is higher than the relative humidity, and the moisture in the ink or cleaning liquid absorbs moisture from the atmosphere if the mole fraction of moisture in the ink or cleaning liquid is lower than the relative humidity; the evaporation/moisture absorption progresses so that formula (3) equals 0, at which point equilibrium is reached.

Although a discharge operation is performed using the suction pump 206 during a cap cleaning operation as illustrated in FIG. 14, the cleaning liquid remains in the cap mechanism 181. During a printing operation following the cap cleaning operation, a cap open state continues, and thus moisture in the cleaning liquid remaining in the cap mechanism 181 evaporates. When the moisture in the cleaning liquid continues to evaporate, the mole fraction of the moisture in the residual cleaning liquid falls below the mole fraction of the moisture in the ink. Thus, while the cap is closed (while the printhead 22 is covered with the cap mechanism 181) after the completion of the printing operation, the moisture in the ink contained within nozzles moves to the cleaning liquid remaining in the cap mechanism 181 until a state of equilibrium is reached in the cap space. This leads to an increase in ink viscosity in the nozzle portion and to ejection failure.

Thus, in the present embodiment, a method will be described in which the cap-cleaning-operation timing is determined by estimating the evaporation ratio of moisture in the cleaning liquid in the cap open state.

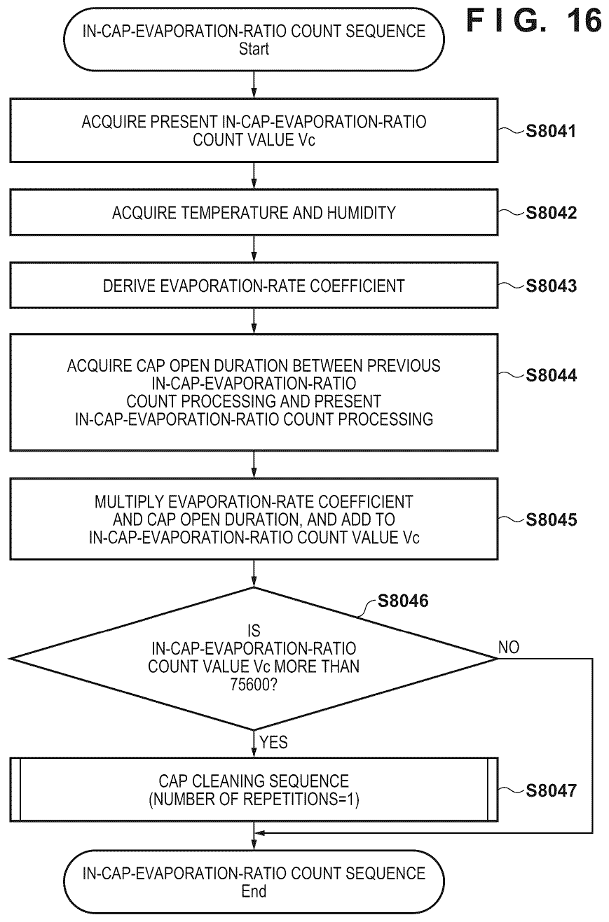

FIG. 16 is a diagram illustrating an in-cap-evaporation-ratio count sequence.

First, the present in-cap-evaporation-ratio count value Vc is acquired (step S8041). The in-cap evaporation ratio is a parameter for managing the degree of progress of evaporation of moisture in the cleaning liquid remaining in the cap mechanism 181.

Next, the temperature and humidity of the installation environment of the inkjet printing apparatus 1 are acquired (step S8042). The inkjet printing apparatus 1 includes a thermo-hygrometer, and the temperature and humidity of the installation environment of the printing apparatus 1 can be acquired at desired timings.

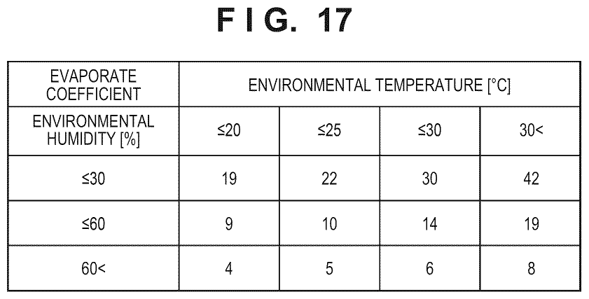

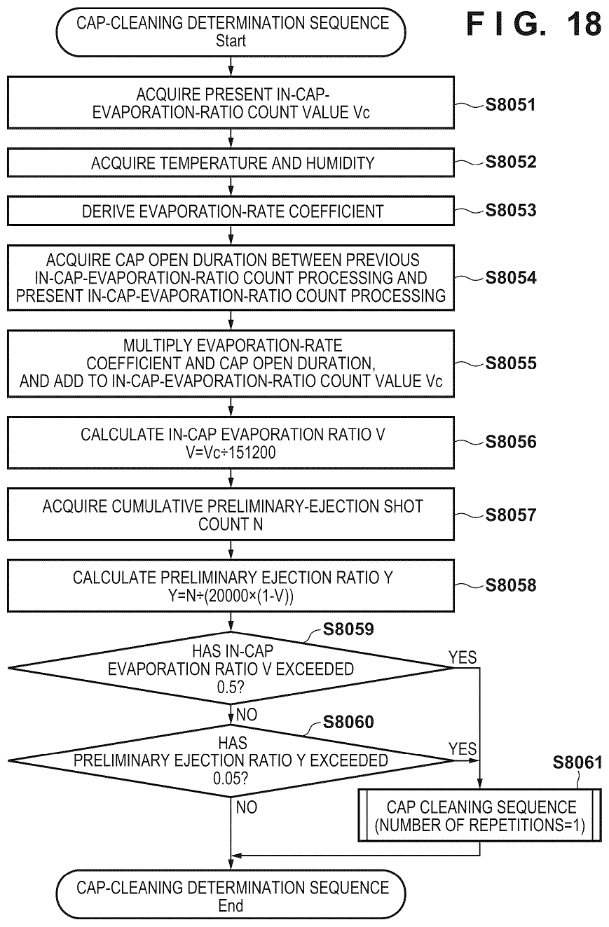

Subsequently, an evaporation-rate coefficient corresponding to the acquired temperature and humidity is derived (step S8043). FIG. 17 is a diagram illustrating a table of evaporation-rate coefficients corresponding to temperatures and humidities. An evaporation-rate coefficient is determined from the present temperature and humidity.

After the evaporation-rate coefficient is derived, a cap open duration between the previous in-cap-evaporation-ratio count processing and the present in-cap-evaporation-ratio count processing is acquired (step S8044).

After the cap open duration is acquired, the evaporation-rate coefficient and the cap open duration are multiplied, and the resultant product is added to the in-cap-evaporation-ratio count value (step S8045).

It is determined whether the in-cap-evaporation-ratio count value is more than or equal to a predetermined threshold (more than or equal to 75600 in the present example) (step S8046). If it is determined that the in-cap-evaporation-ratio count value is more than or equal to the threshold, a cap cleaning operation (number of repetitions=1) is executed (step S8047). On the other hand, the sequence ends without any processing being executed if the in-cap-evaporation-ratio count value is less than the threshold.

In such a manner, in the present embodiment, the evaporation ratio of the cleaning liquid remaining in the cap mechanism 181 is counted to determine the cap-cleaning-operation timing. Thus, excessive use of the cleaning liquid can be suppressed while preventing moisture from moving from the nozzles due to the evaporation of moisture in the residual cleaning liquid in the cap mechanism 181 progressing excessively.

### Fourth Embodiment

In the second embodiment, the cap-cleaning-operation timing is determined based on the cumulative preliminary-ejection shot count. Furthermore, in the third embodiment, the cap-cleaning-operation timing is determined based on the in-cap evaporation ratio. In contrast, in the fourth embodiment, the cap-cleaning-operation timing is determined based on both the cumulative preliminary-ejection shot count and the in-cap evaporation ratio.

FIG. 18 is a diagram illustrating a cap-cleaning determination sequence. The processing up to the addition to the in-cap-evaporation-ratio count value Vc is the same as that in FIG. 16 (steps S8051 to S8055). Subsequently, an in-cap evaporation ratio V is calculated using the following formula (step S8056).

V=in-cap-evaporation-ratio count value Vc/151200. 151200 is a parameter for calculating the evaporation ratio, and is a parameter defining the amount of cleaning liquid remaining in the cap mechanism 181 based on an experimental value. The in-cap evaporation ratio V is calculated because, if the in-cap evaporation ratio V increases excessively, the viscosity of the ink increases rapidly, and cleaning cannot be performed sufficiently in a subsequent cap cleaning operation.

Next, the cumulative preliminary-ejection shot count N is acquired (step S8057). Then, a preliminary ejection ratio Y is calculated using the following formula (step S8058).

Y=N/(20000×(1−V)). 20000 is a parameter for comparing the amount of cleaning liquid remaining in the cap mechanism 181 and the amount of discharge by preliminary ejection. After subtracting the evaporation ratio V of moisture that evaporates while the cap is open from the amount of cleaning liquid remaining in the cap mechanism 181 immediately after a cap cleaning operation, the ratio between an ink amount by preliminary ejection and the amount of cleaning liquid after evaporation is calculated. The preliminary ejection ratio Y is calculated because, if the ratio of the amount of ink ejected by preliminary ejection to the amount of cleaning liquid after evaporation increases excessively, ink viscosity increases rapidly, and cleaning cannot be performed sufficiently in a subsequent cap cleaning operation.

Subsequently, it is determined whether the in-cap evaporation ratio V has exceeded 0.5 (step S8059). Processing transitions to a cap cleaning operation if 0.5 is exceeded (step S8061), whereas subsequent processing of determining whether or not the preliminary ejection ratio Y has exceeded 0.05 is performed if 0.5 is not exceeded (step S8060). Processing transitions to a cap cleaning operation if 0.05 is exceeded, whereas the sequence ends if 0.05 is not exceeded. Both thresholds are parameters defined based on experimental values.

In the present embodiment, the evaporation ratio of the cleaning liquid remaining in the cap mechanism 181 is counted to determine the cap-cleaning-operation timing. Thus, excessive use of the cleaning liquid can be suppressed while preventing moisture from moving from the nozzles due to the evaporation of moisture in the residual cleaning liquid in the cap mechanism 181 progressing excessively.

Furthermore, the cap-cleaning-operation timing is determined by calculating the ratio between the amount of cleaning liquid and a cumulative preliminary ejection amount in a state in which the evaporation ratio of the cleaning liquid is also taken into consideration. Thus, excessive use of the cleaning liquid can be suppressed while preventing the solidification of ink in the cap mechanism 181 and the waste-liquid flow path.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. A printing apparatus comprising:
a cap configured to cap a printhead that ejects a liquid;
a supplying mechanism configured to supply the cap with a cleaning liquid for rinsing out the liquid inside the cap; and
at least one processor or circuit that executes a program and performs operations of the following unit:
a controlling unit configured to control an amount of the cleaning liquid supplied to the cap by the supplying mechanism in accordance with an amount of the liquid discharged from the printhead to the cap.

2. The printing apparatus according to claim 1, wherein the controlling unit increases the amount of the cleaning liquid supplied to the cap by the supplying mechanism commensurately as the amount of the liquid discharged from the printhead to the cap increases.

3. The printing apparatus according to claim 1, wherein the controlling unit performs a supply operation in which the cleaning liquid is supplied to the cap and a discharge operation in which the cleaning liquid is discharged from the cap, and controls the amount of the cleaning liquid supplied to the cap by changing the number of times the supply operation and the discharge operation are repeated.

4. The printing apparatus according to claim 1 further comprising suctioning mechanism for suctioning the liquid from the printhead,
wherein a discharge operation in which the liquid is discharged from the printhead to the cap is performed by the suctioning mechanism.

5. The printing apparatus according to claim 1, wherein a discharge operation in which the liquid is discharged from the printhead to the cap is performed by an eject operation by the printhead in which the liquid is ejected to the cap.

6. The printing apparatus according to claim 5, wherein the at least one processor or circuit executes a program and further performs operations of a counting unit configured to count the number of times the liquid has been ejected to the cap by the printhead, and
wherein the controlling unit controls the amount of the cleaning liquid supplied to the cap by performing control so that the cleaning liquid is supplied to the cap if the number of times the liquid has been ejected, as counted by the counting unit, exceeds a threshold.

7. The printing apparatus according to claim 6, wherein the counting unit counts the number of times a preliminary eject operation from the printhead to the cap has been performed.

8. The printing apparatus according to claim 1, wherein the at least one processor or circuit executes a program and further performs operations of an estimating unit configured to estimate an evaporation ratio of the cleaning liquid inside the cap while the printhead is not capped by the cap, and
wherein the controlling unit supplies the cleaning liquid to the cap if the evaporation ratio of the cleaning liquid exceeds a predetermined value.

9. The printing apparatus according to claim 8, wherein the estimating unit estimates the evaporation ratio of the cleaning liquid, based on an evaporation-rate coefficient corresponding to the temperature and humidity in the printing apparatus.

10. The printing apparatus according to claim 8, wherein the at least one processor or circuit executes a program and further performs operations of the following units:
a counting unit configured to count the number of times the liquid has been ejected to the cap by the printhead; and
a second estimating unit configured to estimate a ratio of the liquid included in the cleaning liquid inside the cap by dividing, by the evaporation ratio of the cleaning liquid, a cumulative liquid ejection amount based on the counting by the counting unit,
wherein the controlling unit supplies the cleaning liquid to the cap if the ratio of the liquid exceeds a predetermined threshold.

11. A method of controlling a printing apparatus comprising: a cap configured to cap a printhead that ejects a liquid; and supplying mechanism configured to supply the cap with a cleaning liquid for rinsing out the liquid inside the cap, the method comprising:
controlling an amount of the cleaning liquid supplied to the cap by the supplying mechanism in accordance with an amount of the liquid discharged from the printhead to the cap.

12. A non-transitory computer-readable storage medium that has stored therein a program for causing a computer to execute a method for controlling a printing apparatus comprising: a cap configured to cap a printhead that ejects a liquid; and supplying mechanism configured to supply the cap with a cleaning liquid for rinsing out the liquid inside the cap, the method comprising:
controlling an amount of the cleaning liquid supplied to the cap by the supplying mechanism in accordance with an amount of the liquid discharged from the printhead to the cap.
